(19) United States
(12) Patent Application Publication
(10) Pub. No.: US 2008/0215892 A1
(43) Pub. Date: Sep. 4, 2008

(54) Data Transmission Between Modules

(76) Inventors: Andreas Lindinger, Flozlingen (DE); Horst Nather, Villingen-Schwenningen (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/913,837

(22) PCT Filed: May 5, 2006
(86) PCT No.: PCT/EP06/62100

§ 371 Date: Nov. 7, 2007

(30) Foreign Application Priority Data
May 12, 2005 (DE) 10 2005 022 112.2

(51) Int. Cl. G07C 5/08; G06F 21/00

(52) U.S. Cl. 713/189

(57) ABSTRACT

In a method for transferring data (D) between a first module (1) and a second module (2), data (D) can be transferred from a data memory (4) of the second module (2) to the first module (1) either in a secured or not secured manner. The time required for authentication (IV) is reduced by first transferring first data (D) in a not secured and then in a secured manner, wherein the data being used by means of a processor (CPU) of the first module (1) for a first process (III). The data (D) transferred in a not secured manner are compared with those transferred in a secured manner and if there is a difference, results from the first process (III) are discarded.

### CROSS-REFERENCE TO RELATED APPLICATIONS

This application is a U.S. national stage application of International Application No. PCT/EP2006/062100 filed May 5, 2006, which designates the United States of America, and claims priority to German application number 10 2005 022 112.2 filed May 12, 2005, the contents of which are hereby incorporated by reference in their entirety.

### TECHNICAL FIELD

The invention relates to a method for transmitting data between a first module and a second module, particularly between a tachograph and a data storage medium which can be connected thereto, where the second module has a data store from which it is possible to transmit data to the first module either in secure form following an authentication operation or in nonsecure form. The invention also relates to an arrangement having a first module and a second module or a tachograph and a connectable data storage medium, where the arrangement is designed to carry out the aforementioned method.

### BACKGROUND

A preferred field of application of the various embodiments is the operation of tachographs, in which a first module or the tachograph is always permanently installed in the commercial vehicle and a second module or the data storage medium, which is usually in the form of a data card, is associated with the driver of the commercial vehicle and can be connected to the tachograph for the purpose of data transmission. Some of the person-related operating data are read from a memory in the data card when the data card is inserted into the tachograph and are subjected to a first evaluation by the tachograph. This involves establishing, inter alia, how long a vehicle driver is permitted to drive taking account of the cumulative interruption to driving time. When the card has been inserted and the data transmission link has been set up, the vehicle driver needs to make inputs on an input apparatus on the tachograph in order to record the work. These include, inter alia, the country in which the card holder is currently located and his intended activity to be performed. According to EEC decree No. 3821/85, the data transmission between the first module and the second module or the tachograph and the data card needs to be carried out in secure form. This requires authentication at the start of the data transmission, during which, inter alia, a session key is produced which is used to secure the transmission of data. However, the time taken for the full authentication operation exceeds a sensibly acceptable period under certain circumstances.

### SUMMARY

The period from setup of a data transmission link between the first module and the second module can be shortened without loss of security against any manipulations up to recording of a data-transmission-based process to a sensible degree according to an embodiment of a method for transmitting data between a first module and a second module, particularly between a tachograph and a data storage medium which can be connected thereto, wherein the second module has a data store from which it is possible to transmit data to the first module either in secure form following an authentication operation or in nonsecure form, wherein the method comprises the steps of: forming a connection of the second module to the first module followed by the transmission of data in nonsecure form which are used by means of a processor in the first module for a first process, following the start of the nonsecure transmission, performing a secure transmission of the data from the second module to the first module, and comparing the data transmitted in nonsecure form with the data transmitted in secure form and results from the first process being discarded if there is a difference between the data transmitted in secure form and the data transmitted in nonsecure form.

According to an embodiment, the data transmitted in nonsecure form may be used for input of additional input data by means of a third module during the first process. According to an embodiment the third module may be in the form of an input apparatus which a user can use to make inputs. According to an embodiment the data may be stored in unencrypted form in a data store in the second module and can be read by the first module.

According to an embodiment, the data transmitted in nonsecure form may be stored in a first area of a memory in the first module. According to an embodiment, for the secure transmission, a key for secure data transmission can be produced during the authentication operation and can be used by the second module to produce at least one control data item from the transmitted data, so that the first module can ascertain the authenticity of the data from an evaluation of the control data item and the transmitted data. According to an embodiment, the key for secure data transmission may be produced by the first module. According to an embodiment, the authentication operation may run as a process in the background. According to an embodiment, the secure transmission and the ascertainment of the authenticity of the transmitted data may take place as processes in the background. According to an embodiment, the authentication operation and the operation of ascertaining the authenticity of the transmitted data can be stored at least in part in a memory in the first module as executable programs in alterable form. According to an embodiment, during the nonsecure transmission of data and the processing of these data certain error messages in the system which can be attributed to the nonsecure transmission may be suppressed.

According to another embodiment, an arrangement may comprise a first module and a second module, wherein data are transmitted between the first module and the second module, wherein the second module has a data store, and the arrangement is in operable to: —transmit from the second module to the first module data in nonsecure form which are used by means of a processor in the first module for a first process, —perform after the nonsecure transmission a secure transmission of the data from the second module to the first module, and—compare the data transmitted in nonsecure form with the data transmitted in secure form and results from the first process being discarded if a difference is ascertained between the data transmitted in secure form and the data transmitted in nonsecure form.

According to an embodiment, the arrangement may be operable to use the data read in nonsecure form to support input of additional data by means of a third module during the first process. According to an embodiment, the third module can be in the form of an input apparatus which a user can use to make inputs. According to an embodiment, the second module may have a data store which stores the data in unencrypted form, and the arrangement may be operable to read the data by the first module. According to an embodiment, the first module may have a memory with a first area, and the arrangement can be operable to use the first area to store the data transmitted in nonsecure form. According to an embodiment, the arrangement can be operable to produce for the secure transmission a key for secure data transmission by the first module during the authentication operation and which may be used by the second module to produce at least one control data item from the transmitted data, so that the first module can ascertain the authenticity of the data from an evaluation of the control data item and the transmitted data. According to an embodiment, the arrangement can be operable to perform the authentication as a process in the background. According to an embodiment, the arrangement can be operable to perform the secure transmission and the ascertainment of the authenticity of the transmitted data as processes in the background. According to an embodiment, the arrangement can be operable to store the operation of authentication and the operation of ascertaining the authenticity of the transmitted data at least in part in a memory in the first module as an executable program in alterable form. According to an embodiment, the arrangement can be operable to suppress during the nonsecure transmission of data and the processing of these data certain error messages in the system which can be attributed to the nonsecure transmission. According to an embodiment, the first module can be a tachograph and the second module can be a connectable data storage medium.

### BRIEF DESCRIPTION OF THE DRAWINGS

The invention is explained in more detail below using a specific exemplary embodiment for the purposes of clarification, where

FIG. 1 shows steps 1 to 6 of an data transmission method with an arrangement according to an embodiment.

### DETAILED DESCRIPTION

According to an embodiment, the nonsecure reading and transmission of data from the second module or the data card of the tachograph to the first module or the tachograph which initially take place mean that it is possible to save the time taken for authenticating or safeguarding the data transmission in advance. This is a particular advantage especially when, according to an embodiment, the data to be transmitted are used for a first process. In this case, the data transmission is thus time-critical for the start of the first process or the overall operation. Using the specific example of the tachograph, the vehicle driver can actually start his input earlier without needing to wait for the results of the authentication operation. There is nevertheless no loss of security again manipulation, since the authentication and the secure transmission of data are subsequently caught up and the data transmitted in secure form are compared with the data transmitted in nonsecure form. If the result of this comparison is negative or if it is possible to establish a difference then the results are discarded from the first process. Using the specific example of the tachograph, discarding means that the vehicle driver's inputs are discarded. In addition, the card advantageously cannot be accepted by the tachograph. The authentication and comparison expediently run under the control of the processor in the background, so that within the context of multitasking the appliance firstly accepts inputs from the user, for example, and, in the specific case of the tachograph, also registers operating data which are transmitted by a sensor arranged in the transmission system during operation of the commercial vehicle. The data which are read in temporarily or in nonsecure form are stored in a memory in the first module or in the tachograph in appropriate fashion and, during or after the secure reading of the data, are compared with said data.

According to an embodiment, the data which are read in nonsecure form assist input of additional data using a third module or an input apparatus on the tachograph during the first process. By way of example, this can involve a language identifier being read from the second module which indicates what language is used on a display unit on the first module to display writing or plain text.

The time saving in the method or when using the arrangement, according to an embodiment, is particularly great if the data are stored in unencrypted form in a data store in the second module and can be read by the first module. This operation or such a form of the arrangement does not have to mean any loss of security if for the secure transmission a key for secure data transmission is produced by the first module during the authentication operation and can be used by the second module to produce at least one control data item from the transmitted data, so that the first module can ascertain the authenticity of the transmitted data from an evaluation of the control data item transferred with the data which are to be transmitted and the transmitted data. The control data item's dependency firstly on the secret key produced and secondly on the other transmitted data safely rules out unnoticed manipulation.

According to various embodiments, it is possible for only the authentication or only the secure transmission to take place under the control of the processor in the background, which already results in significant time savings. It can be particularly advantageous if both the authentication and the transmission take place in the background.

Although, according to various embodiments, a form of the secure transmission and ascertainment of the authenticity of the transmitted data as a hardware component involves relatively little computational complexity and is less time-consuming in operation than the software alternative, it may be preferable for reasons of cost to implement the operations of authenticating and ascertaining the authenticity of the transmitted data as executable programs, at least some of which are stored in alterable form in a memory in the first module. Advantages of the acceleration according to various embodiments take place at the start of the operation of data transmission. So that the nonsecure transmission does not unnoticeably become the norm during normal operation, it makes sense if the system normally reports this state as an error. Such error messages can advantageously be suppressed, during the nonsecure mode for data and the processing of these data, particularly in the time surrounding connection of the first module to the second module or at the start of data transmission between the tachograph and the data storage medium.

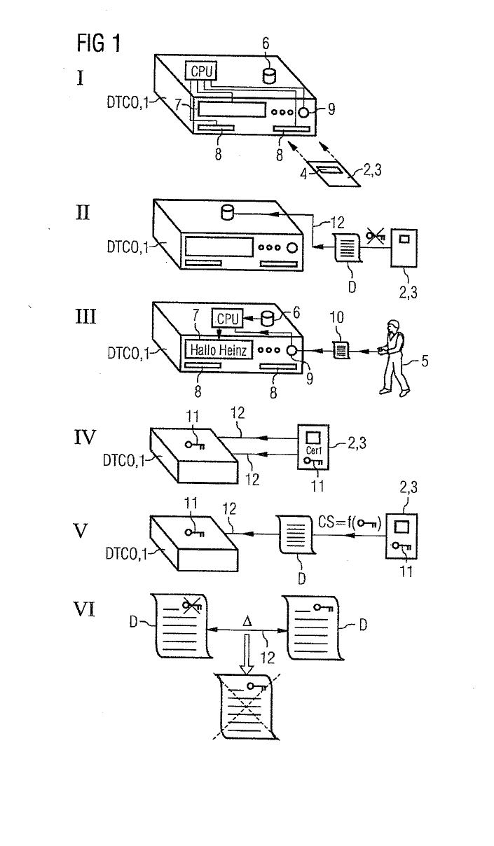

FIG. 1 shows steps I to VI in a method according to an embodiment. FIG. 1 shows a first module 1 or a tachograph DTCO interacting with a second module 2 or a data storage medium 3 in the form of a data card. The second module 2 has a data store 4 which stores person-related operating data for a user 5. The tachograph DTCO has a processor CPU which is connected to a data store 6 in the tachograph DTCO for the purpose of data transmission. In addition, the processor CPU is connected to a display 7, two data card holders 8 and an input apparatus 9 for the purpose of actuation. The data storage medium 3 can be inserted into the data card holder 8 in line with step I which is shown, so that it is inaccessible from the outside. As soon as the data storage medium 3 in the tachograph DTCO is connected 12 to the latter for the purpose of data transmission, data D are transmitted from the data storage medium 3 to the data store 6 in nonsecure form.

During the subsequently shown step III, the user uses the input apparatus 9 to enter input data 10, assisted by the display 7, which displays defaults for the input using the data D transmitted during step II. This first process (III) is controlled by the processor CPU accessing the data store 6.

In the specific exemplary embodiment, input of the input data 10 allows the user 5 to start working or to start driving, and the tachograph DTCO can start to record the operating data on a person-specific basis.

The step denoted by IV is an authentication operation during which a key 11 is produced for protecting the data transmission between the tachograph DTCO and the data storage medium 3. This operation runs in the background to the tachograph DTCO, which is capable of multitasking, like the subsequent operation. During the next step V, the data D are transmitted from the data storage medium 3 to the tachograph DTCO in a manner protected by means of the key 11. The transmission is protected by virtue of unencrypted data D being transmitted together with a control data item CS, the control data item CS being produced as dependent on both the key 11 and the data D. An evaluation of the control data item CS by the tachograph DTCO taking account of the key 11 and the data D shows whether the transmitted data D are authentic or there is manipulation. If authenticity is confirmed, the secure transmission of the data D is deemed to be successful. During the subsequent step VI, the data D successfully transmitted in secure form are compared with the data D transmitted in nonsecure form, which have been stored in the memory 6 of the tachograph DTCO in the interim. If a difference Δ is found, the input data 10 are discarded and the data storage medium 3 or the data card is rejected.

What is claimed is:

1. A method for transmitting data between a first module and a second module, particularly between a tachograph and a data storage medium which can be connected thereto,
wherein the second module has a data store from which it is possible to transmit data to the first module either in secure form following an authentication operation or in nonsecure form, the method comprising the steps of:
forming a connection of the second module to the first module followed by the transmission of data in nonsecure form which are used by means of a processor in the first module for a first process,
following the start of the nonsecure transmission, performing a secure transmission of the data from the second module to the first module, and
comparing the data transmitted in nonsecure form with the data transmitted in secure form and results from the first process being discarded if there is a difference between the data transmitted in secure form and the data transmitted in nonsecure form.

2. The method according to claim 1, wherein the data transmitted in nonsecure form are used for input of additional input data by means of a third module during the first process.

3. The method according to claim 2, wherein the third module is in the form of an input apparatus which a user can use to make inputs.

4. The method according to claim 1, wherein the data are stored in unencrypted form in a data store in the second module and can be read by the first module.

5. The method according to claim 1, wherein the data transmitted in nonsecure form are stored in a first area of a memory in the first module.

6. The method according to claim 1, wherein for the secure transmission a key for secure data transmission is produced during the authentication operation and can be used by the second module to produce at least one control data item from the transmitted data, so that the first module can ascertain the authenticity of the data from an evaluation of the control data item and the transmitted data.

7. The method according to claim 6, wherein the key for secure data transmission is produced by the first module.

8. The method according to claim 1, wherein the authentication operation runs as a process in the background.

9. The method according to claim 1, wherein the secure transmission and the ascertainment of the authenticity of the transmitted data take place as processes in the background.

10. The method according to claim 1, wherein the authentication operation and the operation of ascertaining the authenticity of the transmitted data are stored at least in part in a memory in the first module as executable programs in alterable form.

11. The method according to claim 1, wherein during the nonsecure transmission of data and the processing of these data certain error messages in the system which can be attributed to the nonsecure transmission are suppressed.

12. An arrangement comprising a first module and a second module, wherein data are transmitted between the first module and the second module, wherein
the second module has a data store, and the arrangement is in operable to:
transmit from the second module to the first module data in nonsecure form which are used by means of a processor in the first module for a first process,
perform after the nonsecure transmission a secure transmission of the data from the second module to the first module, and
compare the data transmitted in nonsecure form with the data transmitted in secure form and results from the first process being discarded if a difference is ascertained between the data transmitted in secure form and the data transmitted in nonsecure form.

13. The arrangement according to claim 12, wherein the arrangement is operable to use the data read in nonsecure form to support input of additional data by means of a third module during the first process.

14. The arrangement according to claim 13, wherein the third module is in the form of an input apparatus which a user can use to make inputs.

15. The arrangement according to claim 12, wherein the second module has a data store which stores the data in unencrypted form, and the arrangement is operable to read the data by the first module.

16. The arrangement according to claim 12, wherein the first module has a memory with a first area, and the arrangement is operable to use the first area to store the data transmitted in nonsecure form.

17. The arrangement according to claim 12, wherein the arrangement is operable to produce for the secure transmission a key for secure data transmission by the first module during the authentication operation and which is used by the second module to produce at least one control data item from the transmitted data, so that the first module can ascertain the authenticity of the data from an evaluation of the control data item and the transmitted data.

18. The arrangement according to claim 12, wherein the arrangement is operable to perform the authentication as a process in the background.

19. The arrangement according to claim 12, wherein the arrangement is operable to perform the secure transmission and the ascertainment of the authenticity of the transmitted data as processes in the background.

20. The arrangement according to claim 12, wherein the arrangement is operable to store the operation of authentication and the operation of ascertaining the authenticity of the transmitted data at least in part in a memory in the first module as an executable program in alterable form.

21. The arrangement according to claim 12, wherein the arrangement is operable to suppress during the nonsecure transmission of data and the processing of these data certain error messages in the system which can be attributed to the nonsecure transmission.

22. The arrangement according to claim 12, wherein the first module is a tachograph and the second module is a connectable data storage medium.
